(19) United States
(12) Patent Application Publication
(10) Pub. No.: US 2022/0326187 A1
(43) Pub. Date: Oct. 13, 2022

(54) WORKPIECE TESTING METHOD AND WORKPIECE TESTING SYSTEM

(71) Applicants: HUFSCHMIED ZERSPANUNGSSYSTEME GMBH, BOBINGEN (DE); UNIVERSITÄT AUGSBURG, AUGSBURG (DE)

(72) Inventors: Ralph HUFSCHMIED, BOBINGEN (DE); Markus SAUSE, AUGSBURG (DE); Florian LINSCHEID, AUGSBURG (DE)

(21) Appl. No.: 17/616,288

(22) PCT Filed: May 4, 2020
(86) PCT No.: PCT/EP2020/062283

§ 371 Date: Dec. 3, 2021

(30) Foreign Application Priority Data
Jun. 5, 2019 (DE) 10 2019 003 921.1

(51) Int. Cl. G01N 29/07; G01N 29/48

(52) U.S. Cl. CPC G01N 29/07; G01N 29/48

(57) ABSTRACT

The invention relates to a workpiece testing method, in particular for testing workpieces (5) for internal defects (6), for example workpieces (5) made of fiber-reinforced plastic, comprising the following steps: applying ultrasonic waves (9, 19) to a workpiece (5), detecting ultrasonic signals (10, 20) generated by applying the ultrasonic waves (9, 19) to the workpiece (5), and generating ultrasonic tomogram data of the workpiece (5) from the ultrasonic signals (10, 20). The invention is characterized in that the workpiece (5) is machined, in particular milled, and the ultrasonic waves (9, 19) thus generated are applied to the workpiece (5). The invention furthermore relates to a workpiece testing system suitable therefor.

The invention relates to a workpiece testing method according to the preamble of claim 1, and to a workpiece testing system according to the preamble of claim 15.

In the past, methods based on ultrasound have been used in manufacturing primarily for monitoring chip-cutting or general machining processes and machinery and tool parameters. Thus, for example, international patent specification WO 2018/122119 A1 describes a state monitoring system for a machine tool using structure-borne sound measurements. US patent specification U.S. Pat. No. 4,118,139 A relates to monitoring a state and fracture of a tool using ultrasound measurements, and the European patent specification EP 3 281 741 A describes a machine tool wherein an ultrasound generator in the tool holder simultaneously serves as a sensor and captures a change in the resonant frequency of the tool as a response by the tool to the excitation by means of the ultrasound. A structure-borne sound measurement apparatus for detecting tool fracture on drilling and milling machines is further disclosed in the German patent specification DE 36 27 796 C1. The structure-borne sound sensor is thereby directly coupled to the tool, in that a coolant line is run past the sensor and an open jet of coolant liquid is directed from the end thereof onto the tool.

The European patent specification EP 2 587 230 B1 further discloses capturing ultrasound vibrations arising during machining for observing a workpiece during machining, and feeding the captured vibration spectrum to a multidimensional data analysis as the basis for evaluating the quality of the machining of the workpiece. The three dimensions are thereby spanned by a frequency, time, and amplitude axis, and the landscape visualized therein is compared with known sample landscapes in order to evaluate the quality of the workpiece after machining.

For non-destructive workpiece testing for internal defects in the workpiece not necessarily caused by the machining of the workpiece, ultrasound tomography methods and systems are currently increasingly used, in addition to X-ray and thermographic processes. German patent application DE 10 2005 040 180 A1 mentions the use of ultrasound tomography for visualizing workpieces and the potential defects thereof, wherein measurement values obtained by means of an ultrasound sensor designed as a free jet and mounted on the machine tool and by means of which the workpiece is scanned are used as input data.

Furthermore, the dissertation “Ultrasound tomography for inline workpiece testing on milling machines”, issued in “Berichte aus der Produktionstechnik”, 6/2008, Shaker Verlag, describes how a workpiece set up in a milling machine has ultrasound impulses applied thereto after milling by means of an ultrasound sensor designed as a common HSK tool and built as a free jet, and an ultrasound tomograph of the workpiece is created from the echo responses and allows internal defects of the workpiece to be detected.

Other ultrasound tomography systems used for workpiece testing comprise ultrasonic transmitter/receiver arrays disposed on the workpiece, wherein the workpiece is sequentially scanned by different transmitters, wherein the ultrasonic responses recorded at the other receivers are used for generating an ultrasound tomograph.

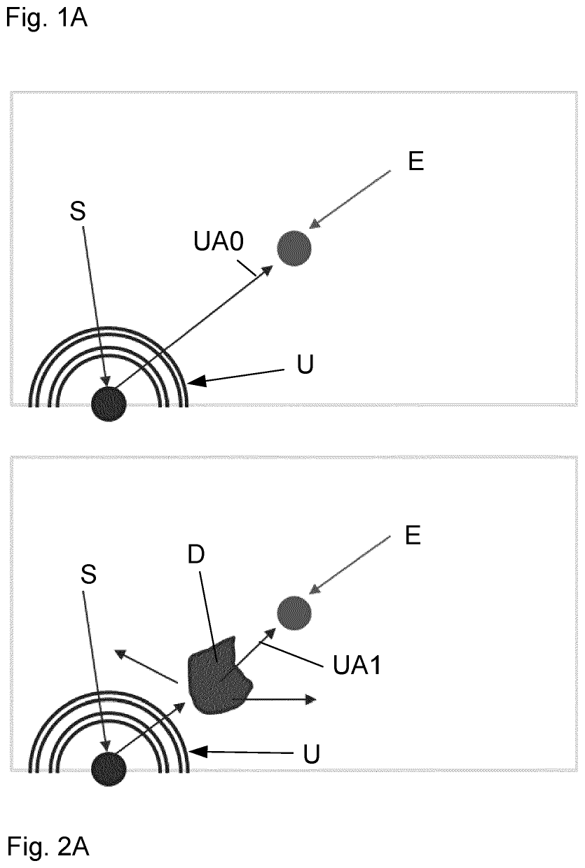

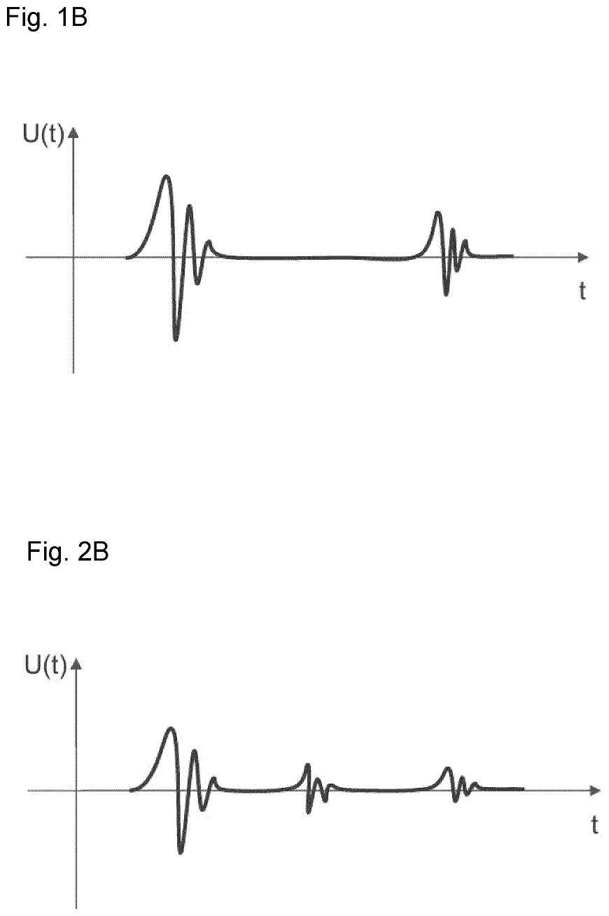

This is explained in greater detail below using FIGS. 1 through 7.

FIG. 1A shows how an ultrasonic transmitter S emits ultrasonic waves U shown as a wavefront, wherein an ultrasound receiver E receives an ultrasonic signal UAO arising from the ultrasonic waves but influenced by the media and conditions along the path between the transmitter and receiver.

Such a condition influencing the received ultrasonic signal can be, for example, an internal defect in a workpiece present along the path of the ultrasonic signal. Such a situation is shown in FIG. 2A. A defect D is present here along the path between the transmitter S and receiver E, at which the ultrasonic waves U are scattered, so that the ultrasonic signal UA1 arriving at the receiver E has a lower amplitude and potentially also other modified properties in comparison with the ultrasonic signal UAO, such as mode conversion or frequency shift, as well as additional signal components.

FIGS. 1B and 2B show the different curves of amplitude over time for the signals UA0—produced without a defect along the path (FIG. 1a)—and UA1—produced with a defect present along the path (FIG. 2A).

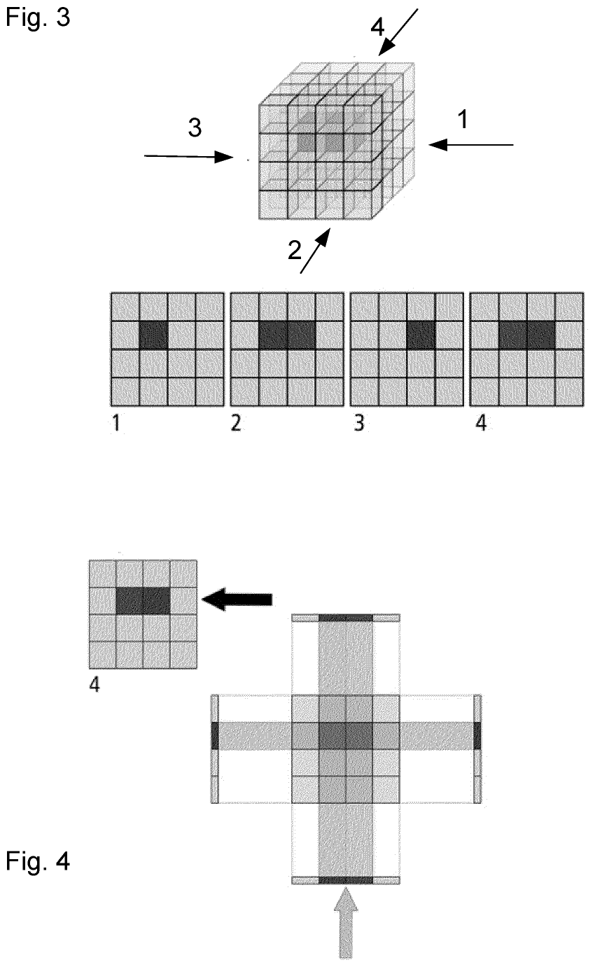

When an ultrasonic signal UA0 through UA n is recorded from sufficient different paths through a workpiece, a tomograph, that is, an image of the interior of the workpiece, can be created by means of a suitable back-projection algorithm, as is explained using FIGS. 3 and 4.

FIG. 3 relates to the data acquisition necessary for tomography, whether ultrasound, magnetic resonance, or nuclear spin tomography. To this end, an object is multilaterally illuminated, irradiated, or scanned, wherein the images obtained thereby represent projections of the body in the direction of permeation.

FIG. 4, in contrast, relates to generating the ultrasound tomograph from the recorded projections, each of which is subdivided into a plurality of points or voxels, wherein a projection is compared layer by layer with projections perpendicular thereto, so that information associated with a point, pixel, or voxel in one projection can be compared with information associated with a series of points, pixels, or voxels in the other projections, so that ultimately the three-dimensional location of the particular point associated with the information can be determined. This is done by means of what is called a back-projection algorithm, or by means of filtered back-projection; mathematically using the inverse radon transformation, for example, wherein other back-projection algorithms are also used.

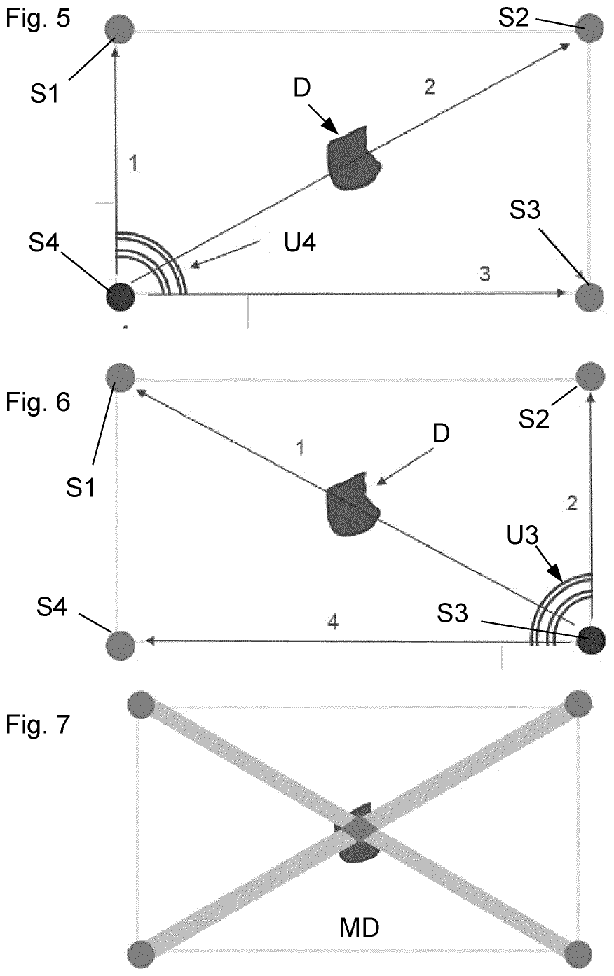

FIGS. 5 and 6 show the disposition of an ultrasound sensor array made of four transmitter-receivers S1 through S4 on a workpiece having an internal defect D. The workpiece in the situation shown in FIG. 5 is thereby scanned by the transmitter S4 by means of the ultrasonic waves U4, wherein the ultrasonic signals 1, 2, 3 are recorded at the corresponding receivers S1, S2, S3 and the ultrasonic signal 2 has, as expected, a different characteristic (such as a lower amplitude) than the other two ultrasonic signals 1, 3, due to the defect D. In FIG. 6, in contrast, the transmitter S3 emits ultrasonic waves U3 by means of which the workpiece is scanned, wherein the ultrasonic signals 1, 2, and 4 are captured at the associated receivers S1, S2, and S4, and wherein there the ultrasonic signal 1 has, as expected, a different characteristic (such as lower amplitude) than the other two ultrasonic signals 2, 4. As shown symbolically in FIG. 7, an ultrasonic tomographic model of the workpiece is produced by means of a suitable back-projection algorithm superimposing the recorded ultrasonic responses serving as projections, said model comprising the modelled representation MD of the defect.

While the existing ultrasonic tomography methods are technically complex, but fundamentally functional, the object of the present invention is to produce a workpiece testing method and a workpiece testing system by means of which at least initial indications of the quality of a workpiece can be obtained in a fast and inexpensive manner.

The object is achieved with respect to the workpiece testing method by the features of claim 1, and with respect to the workpiece testing system by the features of claim 15.

According to the invention, a workpiece testing method is proposed as advantageous particularly for testing workpieces for internal defects and most particularly in conjunction with workpieces made of fiber-reinforced plastics, for which sound dampening occurs due to scattering at the fibers, particularly carbon fibers, as well as sound dampening and directionalities of sound velocities due to the viscoelastic properties of the matrix. To this end, a workpiece is subjected to ultrasonic waves, wherein then subsequently ultrasonic signals are captured as responses of the workpiece to the application of ultrasonic waves to the workpiece, and ultrasound tomography data for the workpiece is generated form the ultrasonic signals. According to the invention, the ultrasonic waves underlying the ultrasound tomography workpiece testing method are such ultrasonic waves as are generated in that the workpiece is machined, wherein the workpiece is forcibly subjected to the ultrasonic waves induced by the machining.

Machining particularly suitable for this purpose is a machining process wherein the workpiece is machined by means of a tool along a specified machining path, said path having a certain extent relative to the size of the workpiece itself, such as milling out a particular contour along an inner or outer edge of a workpiece, wherein theoretically a turning or other milling process, such as finishing or roughing, can be made the starting point of the proposed ultrasonic tomography workpiece testing method.

In series of tests, the method has been found to be particularly successful when milling along workpieces or workpiece segments having thin walls, particularly flat workpieces or workpiece segments of constant thickness where possible, such as plate-shaped workpieces made of carbon-reinforced plastic, and particularly when the machining path traveled in the milling process underlying the method follows an outer contour fully or at least mostly enclosing the workpiece.

The invention is thereby based on the idea that a change in the wave propagation can be expected when an internal defect is present in the path of the ultrasonic waves. When the propagation of the ultrasonic waves generated by the machining of the workpiece changes, however, an ultrasonic signal detectable by a sensor also changes and can be captured as a response of the workpiece to the application of the ultrasonic waves. This is because scattering and partial reflection of the ultrasonic waves, including amplitude attenuation, occurs at the boundary surfaces of the defect.

According to the invention, it would thereby be theoretically conceivable to capture ultrasonic signals as responses of the workpiece to the ultrasonic waves continuously generated during machining of the workpiece in an impulse-echo process by means of a sensor mounted on the tool or on the chuck of the tool.

Better results in terms of amplitude and having substantially less noise are achieved, however, when the ultrasonic signals are captured directly at the workpiece. In principle, various ultrasonic sensor form factors are suitable for this purpose, such as free jet sensors, collar-style ultrasonic sensors, or optically coupled systems. A particularly simple structure and thus particularly suitable structure with respect to inline application of the workpiece testing method during machining is obtained, however, when a sensor having the form of a contact sensor and mounted on the workpiece before the ultrasonic signals are captured is used as the ultrasonic sensor. To this end, it is conceivable to provide the workpiece to be tested with a reference marking or even a corresponding receptacle for locating the sensor in a preceding method step.

It has been found that particularly when an overall outer contour of a workpiece is traveled during the milling process, it is sufficient to mount a single sensor on the workpiece, wherein when traveling shorter machining paths, adding further sensors at suitable positions can be used for generating a sufficient number of ultrasonic responses for producing an ultrasonic tomograph. Mounting a sensor array on the workpiece is thus not excluded in the scope of the invention, but can be advantageously avoided in the sense of a structure having only one sensor and particularly of use during the milling of the workpiece.

It must be considered that the step of machining, particularly milling, should advantageously simultaneously be a machining step in the manufacture of the workpiece, that is, not purely a step of reference machining in a separate workpiece testing method, but rather an integral production step simultaneously providing the basis for performing the workpiece testing method during the actual production of the workpiece. It would be conceivable, however, to perform a reference machining segment in advance in the setup of the workpiece for production as a starting point for the workpiece testing method according to the invention, before the actual, final milling to the final dimensions of the workpiece.

It is further advantageous in the sense of easily evaluating the quality of the ultrasonic signals generated in the workpiece to perform scanning of the workpiece, that is, from the mill to the sensor mounted on the workpiece, and also further advantageous for processing the ultrasonic signals to incorporate the path of the ultrasonic signals, continuously changing during machining, from a changing instantaneous position of the mill to the constant position of the sensor.

In addition to the machining path, the tool feed rate, the tool speed, and/or the tool geometry and material parameters can be specified or determined or read out from the machine controller, for example, as well as the workpiece parameters (thickness, material, etc.) and incorporated for processing the ultrasonic signals and generating the ultrasonic tomograph data. It would even be conceivable to provide segments having a reference geometry on the workpiece for the milling process underlying the workpiece testing.

The ultrasonic signals captured by the sensor or sensors can thereby be saved and processed into ultrasonic tomograph data in a subsequent step. It is advantageous in the sense of rapid evaluation, however, when the producing of the ultrasonic tomograph data is already at least begun during machining or milling, or the producing of ultrasonic tomograph data even takes place in real time or after a slight time delay.

An ultrasonic tomograph is thereby an image of the interior of the workpiece generated by means of ultrasound and able to be displayed on a display device, for example, a display of a control center of a machine tool, for example, from data or data sets constructed in a number of files or data flows and corresponding known imaging principles.

In the sense of the method according to the invention, only such data underlying the ultrasonic tomograph, the ultrasonic tomograph data, can be generated and then fed to a mechanical or (partially) automated evaluation for internal defects of the workpiece. It would also be conceivable, of course, to visualize the generated ultrasonic tomograph data as an ultrasonic tomograph in an imaging step preceding the testing of the ultrasonic tomograph data, said tomograph then also being able to be evaluated mechanically or by a human workpiece inspector. The ultrasonic tomograph can thereby be imaged on a model of the workpiece present in current computer-aided manufacturing systems, for example, in the form of CAD or CAM data.

In practice, it has been found that not only can a sufficiently high number of ultrasonic signals for producing an ultrasonic tomograph, or the ultrasonic tomograph data underlying the tomograph, be provided by means of the method according to the invention, but also that, on the contrary, it can be desirable with respect to the desired inline processing of data during the machining or milling process and even necessary with respect to the computing capacity to be provided to limit the flood of data and/or to improve the ultrasonic signals or ultrasonic responses to be processed prior to processing the same, in order to facilitate and thus to accelerate producing the ultrasonic tomograph or the ultrasonic tomograph data.

To this end, filtering of the ultrasonic signals can take place prior to processing the ultrasonic signals into ultrasonic tomograph data, for example, by means of suitable bandwidth filters, in order to forward only those frequency bands to processing in which suitable signal information is expected, and thus not only to filter out background noise, but rather also to perform a certain reduction of the data to only the essentials.

For machining different reference workpieces, it has been found that the frequency spectrum produced by the machining or milling can potentially comprise different preferred frequencies, depending on the workpiece, at which an ultrasonic wave is generated continuously or nearly continuously over the course of ongoing milling, said wave having sufficient signal strength for analyzing the ultrasonic signal based on the ultrasonic wave of said frequency.

The frequency spectrum within which the ultrasonic signals are captured, or the frequency spectrum of the ultrasonic signals from which the ultrasonic tomograph data is produced, is advantageously limited to corresponding preferred frequencies, potentially having narrow frequency bands about the same, in order to thus obtain a high analysis speed at a relatively modest computing effort by means of data reduction.

Which frequency or frequency bands are particularly suitable for the method according to the invention performed on a particular workpiece can be determined using previously performed milling of identical workpieces using the same machining parameters, while capturing the frequency spectrum thus arising, or from previously saved empirical values, wherein it would also be conceivable to save empirical values or digital fingerprints in databases for particular tools, machines, and workpieces, and to calculate or at least estimate corresponding empirical values from the same for the preferred frequencies suitable for ultrasonic tomography.

Determining the number of frequencies or frequency bands suitable for the significance of the ultrasonic signals captured by the sensor nevertheless advantageously takes place during milling producing ultrasonic waves, from which the ultrasonic signals are produced and the ultrasonic tomography data is generated, that is, inline during the milling process step. The signal strength of the ultrasonic signals can thereby be captured during milling at various frequencies and/or frequency bands distributed over the ultrasonic spectrum, wherein the determining of the suitable frequencies or frequency bands can then involve selecting one or more frequencies and/or frequency bands having increased signal strength relative to an average signal strength.

Said selecting can be continuously adapted by means of self-learning A1 algorithms during milling to the results achievable by means of the current ultrasonic signal or the expected results under consideration of particular tendencies of changes to the ultrasonic spectrum during machining, wherein it would also be conceivable, for example, to simply mask one phase for the ultrasonic workpiece testing at the beginning of the milling process, or other machining phases in which positioning motions are performed without contact between the tool and the workpiece, for example, or at position with abrupt changes in thickness or undercuts on the workpiece or the like.

The amplitude of an ultrasonic wave of a preferred frequency encountering no obstacle along the path from the cutter to the sensor, that is, no internal defect or hole or the like, can be relatively accurately determined beforehand when the length of the path is known, for example. The path can then be divided into segments of equal length, and in the simplest case an equal portion of the amplitude of the ultrasonic response at the selected frequency is associated with each. If, however, a defect is present in the path, then the amplitude is reduced, so that a lesser portion of the amplitude is associated with each path segment.

For back projecting, or producing the ultrasonic tomograph data, in the simplest case only the paths must be divided into path segments of equal length, as well as the ultrasonic signals associated with the paths, such as the amplitude of the captured ultrasonic signal in the range of a preferred frequency. By means of a suitable back-projection algorithm, the individual segments of the different paths can then be superimposed with the amplitude portions associated with the different captured ultrasonic signals by summation, in order to thus produce an image of the interior of the workpiece, namely the ultrasonic tomograph of the workpiece or the ultrasonic tomograph data underlying the ultrasonic tomograph.

It would of course also be conceivable to evaluate other signal characteristics potentially changed due to internal defects, in addition to or alternatively to the amplitude, such as a modal composition or frequency shifts.

It would also be conceivable to divide the paths as a function of acoustic properties of the workpiece in the corresponding path segment, for example, not into path segments of equal length, but rather into longer and shorter path segments.

In any case, it is fundamental to the workpiece testing method according to the invention that during the machining of the workpiece it is continuously captured whether the machining is inducing ultrasonic waves in the workpiece, or whether and which ultrasonic signal is arriving at the sensor, and/or that ultrasonic signals are continuously captured there. Therefore, the ultrasonic signals must initially be set with respect to the momentary location of the machining tool or the momentary machining position at which the momentary machining of the workpiece is taking place. The captured ultrasonic signal can then be associated with a particular signal path between the tool and the sensor. Said association could take place by means of an iterative search algorithm for determining the shortest distance between two selected points from the connection logic of a point cloud.

The tool position can thereby be read out from the machine controller or the NC travel paths saved in the machine in the machine coordinate system and transformed into a workpiece coordinate system, wherein the potential offset between an origin coordinate of the tool saved in the machine coordinate system and a contact point on the workpiece, that is, a momentary machining position, can be determined by means of the known tool geometry, and said geometry can also be read from data sets saved in the machine.

It is thus advantageous that the momentary machining position at which the tool contacts the workpiece at a momentary time is continuously captured, determined, and/or provided during the machining of the workpiece. The present path between the momentary machining position, varying over the course of machining, and the fixed sensor position can also further advantageously be continuously captured, determined, and/or provided. A travel time of the ultrasonic signals from the momentary machining position to the sensor position can also be continuously captured, determined, and/or provided.

It must thereby be considered that the signal path need not necessarily correspond to a geometrically shortest line in the workpiece. Rather, said path depends on the course of the acoustic connection line between the momentary machining position and the sensor position in the workpiece. The acoustic connection line in the workpiece can deviate significantly from the geometrically shortest connection line, particularly for a complex geometry of the workpiece, but can be determined by means of search algorithms from the discretized CAD/CAM data of the workpiece, for example.

Therefore, an acoustic connection line in the workpiece from the momentary machining position to the sensor is advantageously determined for each momentary machining position for which an ultrasound signal is captured and is associated with the momentary machining position and/or the ultrasonic signal. The acoustic connection line thereby corresponds to the signal path between the momentary machining position and the sensor. The position values formed from the momentary machining position and/or the momentary path and potentially also the travel time values formed from the corresponding travel time can then be associated with each ultrasonic signal, or at least each ultrasonic signal of significance and/or used for producing the ultrasonic tomograph data, in order to thus be able to perform the back-projection algorithm necessary for producing the ultrasonic tomograph data. For the back projection, a simple summation of the intensity values of the corresponding ultrasonic signals associated with a point intersected by a plurality of paths can take place. It would also be conceivable to have a path-dependent compensation of the courses of the corresponding acoustic connection paths, that is, the paths of the ultrasonic signals flow into the back-projection algorithm. Thus, for example, at locations where the paths are densely superimposed, the intensity values are multiplied by a lower factor than at locations where the paths are spaced comparably far apart.

The workpiece testing system according to the invention thereby comprises an entity generally referred to as a processing unit, by means of which the method steps of the workpiece testing method can be implemented on a computer-aided basis. The processing unit can thereby be implemented as an independent computer or computer network on which the corresponding software routines run, in order to capture incoming ultrasonic signals from coupled ultrasonic sensors or from one coupled ultrasonic sensor as input variables, wherein the ultrasonic signals arise from the ultrasonic waves produced at the workpiece during machining, particularly milling, of the workpiece, and in order to produce the ultrasonic tomograph data of the workpiece. The processing unit can, however, thereby also be a machine control unit integrated in the machine, or corresponding workpiece testing routines can be placed as a module for supplementing the machine controller in the control computer of the machine tool or, at least relating to steps requiring intensive processing, on a large-capacity external computer.

A substantial advantage of the invention is the elimination or reduction of subsequent testing processes for machine components. Depending on the manufacturing process selected, said processes are substantial cost components and can be implemented by means of the workpiece testing method and system according to the invention extremely inexpensively and without additional time requirements. At the same time, it can be assumed that the selected approach is superior to classic methods of ultrasonic tomography in that a higher resolution can be achieved.

This is because ultrasonic signals can be captured at a higher number of momentary machining positions due to the excitation by means of the machining tool during the machining of the workpiece, knowing the position of the machining tool. For an application of N sensors on the workpiece and M momentary machining positions each associated with an ultrasonic response, MN ultrasonic signal in MN scanning directions can thus be captured and used for producing ultrasonic tomograph data. For the classic case of ultrasonic tomography by means of static scanning in a sensor array, in contrast, for a number of N transducers, only (N−1)^{N} directions are possible. Because M can be much greater than N, that is, the momentary machining positions for which ultrasonic signals can be captured can greatly exceed the number of transducers, the workpiece testing method and system according to the invention can fundamentally achieve a significantly more acute approximation of internal defects.

The paths or scanning directions each thereby extend along the acoustic connection lines to the sensor and thus form a mesh having a fixed central point at which the back-projection algorithm can start. It has been found that defects in the range of cm² can be detected, and such are common defect sizes relevant to detection in the field of aviation. It is assumed, however, that in principle even smaller defect sizes down to the range of mm² can also be detected.

For the example of machining a peripheral edge of an aluminum plate having dimensions of 1 m×1 m at a feed speed of 0.1 m per second and a speed of sound of 3000 meters per second, a calculation potential using only one sensor at the center of the plate (N=1) of M=240964 detectable momentary machining positions results when using 166 ps signal propagation time for the shortest path (0.5 m). This results in 240964¹ scanning directions. In the classic approach according to FIGS. 5 and 6, at least seven transducers or transmitter-receivers would need to be used in order to obtain a comparable resolution.

By using the machining process itself as a signal source for ultrasonic tomography, ultrasonic tomography of the workpiece can be performed inline for the first time, that is, during a machining process on the machine for machining a workpiece set up thereon for machining.

A workpiece testing method according to an embodiment of the invention and the differences between the same and a known ultrasonic tomography workpiece testing method are explained in greater detail using the attached figures. They show:

FIGS. 1A and 2A principle sketches showing the producing of different ultrasonic signals under identical ultrasonic excitation as a function of the absence or presence of an internal defect in a scanned workpiece;

FIGS. 1B and 2B the ultrasonic signals produced in the absence or presence of the internal defect under identical ultrasonic excitation;

FIGS. 3 and 4 principle schematics for explaining data acquisition and back projection for tomography;

FIGS. 5-7 explain the procedure for a known ultrasonic tomography workpiece testing method;

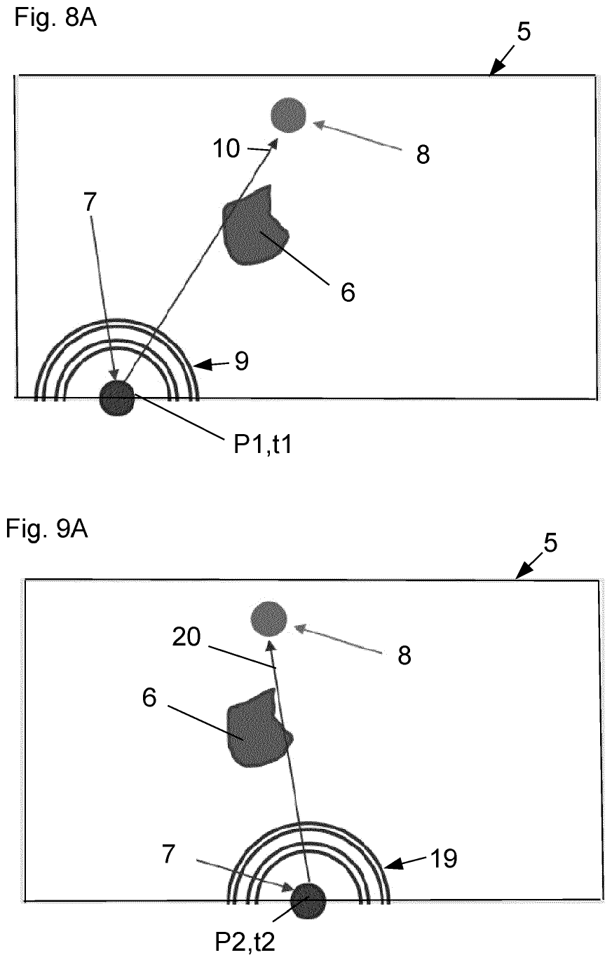

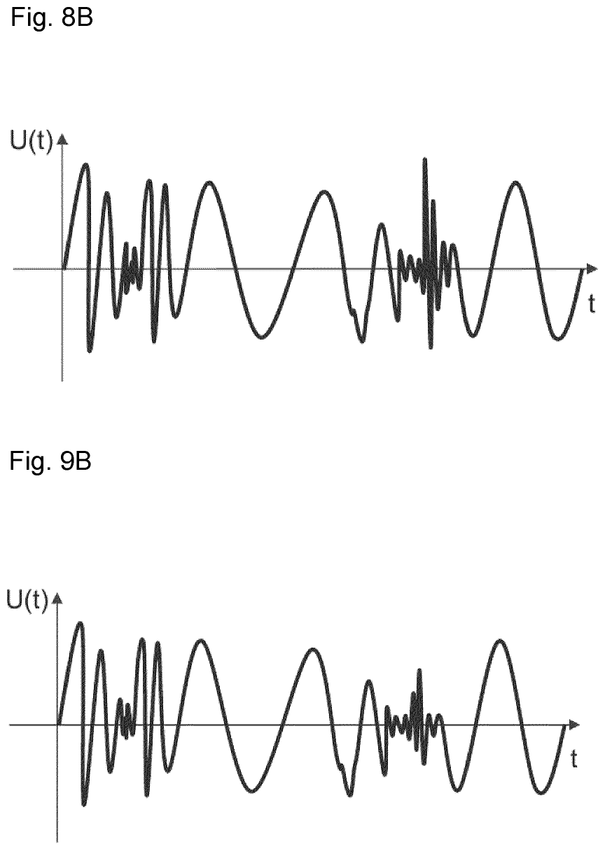

FIGS. 8A and 9A show, in contrast, a principle sketch of a sequence of milling during a workpiece testing method according to an embodiment of the invention, wherein ultrasonic signals are captured at different momentary machining positions;

FIGS. 8B and 9B show the ultrasonic signals captured for the momentary machining positions according to FIG. 8A and FIG. 9A;

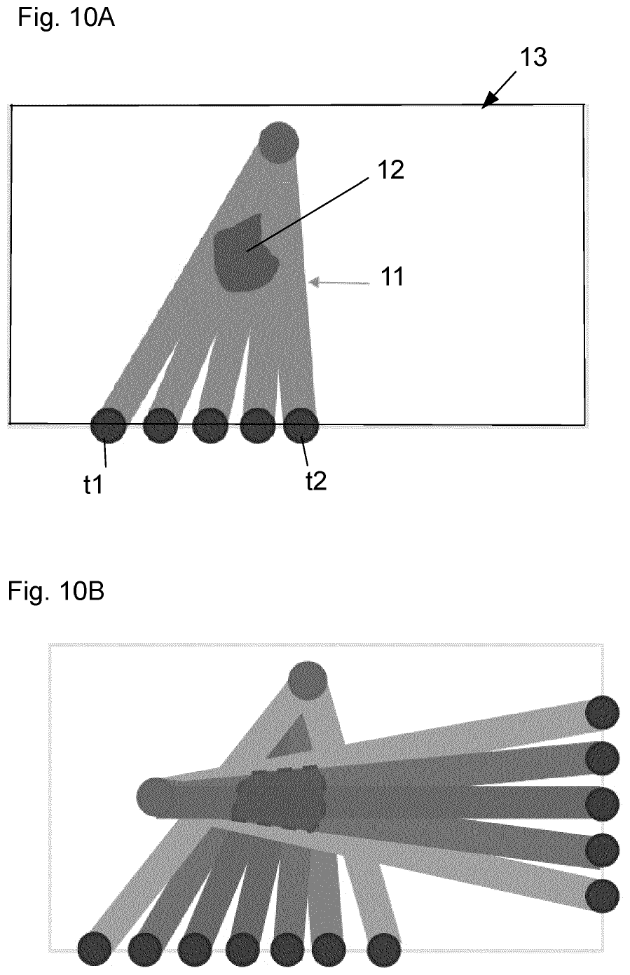

FIG. 10A shows a representation of the back projection, that is, the producing of ultrasonic tomography data in the workpiece testing method according to the embodiment of the invention shown in FIG. 8A through 9B;

FIG. 10B shows a representation of the back projection for an alternative embodiment of the invention using two ultrasonic sensors;

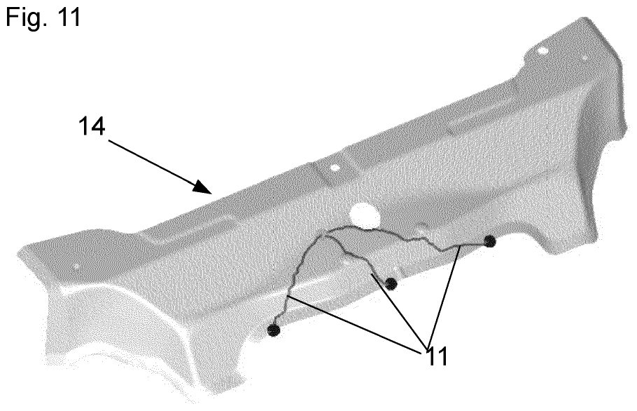

FIG. 11 shows a CAD model of a workpiece tested by means of the workpiece testing method principally explained in FIGS. 8A through 10A, with acoustic connection lines shown; and

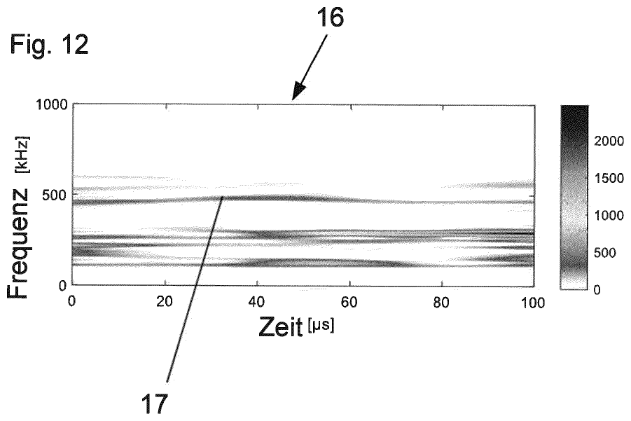

FIG. 12 shows an example of an ultrasonic signal captured when executing the workpiece testing method according to FIG. 8A through 10A as a time-frequency representation.

As FIGS. 1-7 relating to a known ultrasonic tomography workpiece testing method have already been explained above, reference is now made to FIGS. 8 through 12, relating to workpiece testing methods according to embodiments of the invention.

FIGS. 8A and 9A show a workpiece 5 during milling by means of a cutter 7 at two different points in time t1 (FIG. 8A) and t2 (FIG. 9A). It is evident that the cutter 7 has been displaced from a momentary machining position P1 at the time t1 shown in FIG. 8A to a momentary machining position P2 at the time t2 shown in FIG. 9A somewhat to the right along the bottom edge of the workpiece during ongoing milling.

At the point in time t1, the milling thereby produces ultrasonic waves 9 shown as a wavefront, and at the point in time t2 ultrasonic waves 19 also shown as a wavefront, said wavefronts being not necessarily identical, but not substantially changing due to the unchanged feed speed, rotary speed, and penetration depth of the cutter 7. What can change in the course of milling, however, is an ultrasonic signal captured by an ultrasonic sensor 8 mounted on a workpiece 5. The ultrasonic signal captured at time t1 is thereby indicated by reference numeral 10, and the ultrasonic signal captured at time t2 by reference numeral 20. Furthermore, an internal defect 6 present in the workpiece is evident and said defect enters the signal path as the mill 7 passes by along the bottom edge of the workpiece and thus influences the ultrasonic signals continuously captured at the ultrasonic sensor 8.

FIGS. 8B and 9B show the different amplitude curve over time for signals 10—induced at the momentary machining position shown in FIG. 8A—and 20—induced at the momentary machining position shown in FIG. 8A. Deviations are evident after approximately two-thirds of the recorded time, that is, at a position corresponding to the position of the defect 6.

FIG. 10A illustrates how a reconstruction of inhomogeneities is performed by means of a back-projection algorithm. Along the signal paths taken between t1 and t2 at various points in time, the back projection of the associated ultrasonic responses are superimposed by means of a suitable back-projection algorithm, leading to producing an ultrasonic tomograph 13 of the workpiece 5 including an image 12 of the internal defect 6. For the back-projection algorithm, the different angular orientation of the signal paths or scanning directions must be taken into consideration, as in the conversion of a scan from only four sides, as shown in FIG. 3, said orientation leads to a sensor-centered mesh under a substantially tighter angular increment rather than to a mesh of voxels of equal size as in static tomography methods. The signal paths further do not, in reality, typically follow a straight line 11 as shown in FIG. 10A only as an example and for explanation purposes.

FIG. 10B illustrates the back-projection algorithm for an alternative embodiment of the invention, wherein two sensors are disposed on the workpiece for capturing ultrasonic signals at different positions. The signals here are overlapping signal paths between the momentary machining position and the first ultrasonic sensor on the oner hand, and between the momentary machining position and the second ultrasonic sensor on the other hand. Therefore, double the number of signals are available on overlapping paths for performing the back-projection algorithm. An even more precise image of the internal defect can thereby be created than for the embodiment of the invention wherein only one sensor is present for capturing the ultrasonic signals.

Reference is made to FIG. 11, showing a CAD model of a reference workpiece for which the workpiece testing method according to the explained embodiment of the invention can be performed. Acoustic connection lines 11 between a sensor position and three momentary machining positions at three points in time are drawn in the CAD model 14, thus corresponding to the signal paths at the three points in time during machining along an edge at the bottom of the image on a reference workpiece. It is evident that the course of the acoustic connection lines can also have a decisive influence for the back projection and therefore should be included in the back-projection algorithm. The ultrasonic tomograph shown merely as a principle in FIG. 10 can be placed on the CAD model 14, so that the location of the defect 6 and an image thereof 12 are readily evident.

FIG. 12 finally shows a time-frequency chart 16 of the ultrasonic signals captured while performing the workpiece testing method. A preferred frequency band 17 in the range just below 500 kHz is significantly evident, in which a strong signal is captured during the entire course of machining over time, so that the capturing of the ultrasonic responses and the processing thereof can be limited to said range.

Modifications of and derivations from the workpiece testing method shown and explained are possible without departing from the scope of the invention.

The workpiece testing method according to the invention is particularly well suited for testing workpieces for internal defects. The workpiece testing method according to the invention is suitable, for example, for testing workpieces made of fiber-reinforced plastic. It is thereby advantageous if the workpiece is milled and the workpiece is subjected to ultrasonic waves produced thereby.

It is further advantageous if the ultrasonic signals of the workpiece are captured by means of a single one or two preferably piezoelectric sensors. The sensor is preferably a contact sensor and is mounted on the workpiece prior to capturing the ultrasonic signals of the workpiece.

It is further advantageous thereby that the machining of the workpiece takes place by means of a tool along a specified machining path, namely along an outer contour running all around the workpiece, and particularly at a specified tool feed rate.

Each captured ultrasonic signal is further advantageously associated with: a number of associated momentary machining positions and/or a number of position values corresponding to the associated momentary path between the momentary machining position and the sensor position, and/or a number of time values corresponding to the associated time the ultrasonic waves arise at the associated momentary machining position, and/or a number of running time values corresponding to the associated running time of the ultrasonic waves from the associated momentary machining position to the sensor position.

A back-projection algorithm having an inverse radon transformation is further advantageously performed for producing ultrasonic tomograph data using the ultrasonic signals associated with the particular number of position values and/or the particular number of running time values.

The ultrasonic waves and/or the ultrasonic signals are further advantageously filtered to a number of particular frequencies or frequency bands prior to performing the back-projection algorithm and prior to associating the position values and/or running time values with the ultrasonic signals, and only those ultrasonic signals corresponding to the number of particular frequencies or within the number of particular frequency bands and/or only the portion of ultrasonic signals corresponding to the number of particular frequencies or within the number of particular frequency bands are captured and/or used for producing the ultrasonic tomograph data.

The number of frequencies or frequency bands suitable for validity of the ultrasonic signals is thereby further advantageously determined by capturing a signal strength of the ultrasonic signals at various frequencies and/or frequency bands distributed over an ultrasound spectrum during machining and by selecting one or more frequencies and/or frequency bands having increased signal strength relative to an average signal strength.

The ultrasonic tomograph data produced is thereby further advantageously visualized in a subsequent imaging step as an ultrasonic tomograph on a model of the workpiece or a workpiece segment existing or created as CAD/CAM data.

The workpiece testing system according to the invention is particularly well suited for testing workpieces for internal defects. The workpiece testing system according to the invention is suitable, for example, for testing workpieces made of fiber-reinforced plastic. The processing unit is thereby particularly integrated in a machine tool, preferably a milling machine tool. One single or two ultrasonic sensors are suitable as a number of ultrasonic sensors used for capturing and outputting output variables. The ultrasonic sensor or sensors are particularly piezoelectric sensors and preferably contact sensors suitable for mounting on the workpiece. The processing unit is particularly set up for receiving ultrasonic signals as the input variable produced by applying ultrasonic waves to the workpiece by means of milling the workpiece. The processing unit is thereby particularly set up for performing the method steps according to any one of the claims 7 through 14 and/or particularly for controlling the machine for machining, particularly for milling the workpiece for producing the ultrasonic waves and/or for controlling the machine for performing the method steps according to any one of the claim 2, 5, or 6.

1. A workpiece testing method having the following steps:
applying ultrasonic waves (9, 19) to a workpiece (5), capturing ultrasonic signals (10, 20) produced by applying the ultrasonic waves (9, 19) to the workpiece (5),
producing ultrasonic tomograph data of the workpiece (5) from the ultrasonic signals (10,

20,
characterized in that
the workpiece (5) is machined and the ultrasonic waves (9, 19) thus produced are applied to the workpiece (5).

2. The workpiece testing method according to claim 1, characterized in that the workpiece (5) is manufactured by means of machining, by means of which the ultrasonic waves (9, 19) are produced and applied to the workpiece (5).

3. The workpiece testing method according to claim 1, characterized in that the ultrasonic signals (10, 20) of the workpiece are captured by means of a number of sensors (8).

4. The workpiece testing method according to claim 3, characterized in that the sensor (8) is mounted on the workpiece (5) prior to capturing the ultrasonic signals (10, 20) of the workpiece (5).

5. The workpiece testing method according to claim 1, characterized in that the machining of the workpiece (5) takes place by means of a tool (7) along a specified machining path.

6. The workpiece testing method according to claim 1, characterized in that the workpiece (5) is scanned by means of the ultrasonic waves (9, 19) and the ultrasonic signals (10, 20) of the workpiece (5) arising from propagation of the ultrasonic waves (9, 19) along paths (11) through the workpiece are captured, wherein the path (11) changes continuously as the machining progresses.

7. The workpiece testing method according to claim 1, characterized in that the ultrasonic tomograph data is completely or at least partially produced during the machining.

8. The workpiece testing method according to claim 3, characterized in that during the machining of the workpiece (5), position values corresponding to a momentary machining position (P1, P2) and/or a momentary path (11) between the momentary machining position (P1, P2) and a sensor position, and/or
time values corresponding to a time at which the ultrasonic waves (9, 19) are produced at the associated momentary machining position (P1, P2) are continuously captured, determined, and/or provided, and/or
running time values corresponding to a running time of the ultrasonic waves (9, 19) from the associated momentary machining position (P1, P2) to the sensor position are captured, determined, and/or provided.

9. The workpiece testing method according to claim 8, characterized in that
a number of position values corresponding to the associated momentary machining position (P1, P2) and/or the associated momentary path (11) between the momentary machining position (P1, P2) and the sensor position, and/or
a number of time values corresponding to a time at which the ultrasonic waves (9, 19) are produced at the associated momentary machining position (P1, P2), and/or
a number of running time values corresponding to a running time of the ultrasonic waves (9, 19) from the associated momentary machining position (P1, P2) are associated with a plurality of captured ultrasonic signals (10, 20).

10. The workpiece testing method according to claim 9, characterized in that a back-projection algorithm is performed for producing the ultrasonic tomograph data using ultrasonic signals (10, 20) associated with the corresponding number of position values and/or the corresponding number of running time values.

11. The workpiece testing method according to claim 10, characterized in that the ultrasonic waves (9, 19) and/or the ultrasonic signals (10, 20) are filtered to a number of particular frequencies or frequency bands (17) prior to performing the back-projection algorithm, and
only those ultrasonic signals corresponding to the number of particular frequencies or within the number of particular frequency bands and/or
only the portion of the ultrasonic signals (10, 20) corresponding to the number of particular frequencies or within the number of particular frequency bands are captured and/or used for producing the ultrasonic tomograph data.

12. The workpiece testing method according to claim 11, characterized in that the number of frequencies or frequency bands (17) suitable for validity of the ultrasonic signals is determined.

13. The workpiece testing method according to claim 1, characterized in that the ultrasonic tomograph data produced are visualized in a subsequent imaging step as an ultrasonic tomograph (13).

14. The workpiece testing method according to claim 13, characterized in that the ultrasonic tomograph data and/or the ultrasonic tomograph (13) of the workpiece (5) is subsequently evaluated for internal defects (6) in the workpiece (5).

15. A workpiece testing system having:
a distributed or local processing unit having an interface for receiving as input variables the output variables captured and output by a number of ultrasonic sensors (8), characterized in that the processing unit is set up
for receiving ultrasonic signals (10, 20) as the input variables produced by applying ultrasonic waves (9, 19) to the workpiece (5) by means of machining and captured and output by the number of sensors as output variables, and
for producing ultrasonic tomograph data of the workpiece (5) from the input variables.

16. The workpiece testing method according to claim 2, characterized in that the ultrasonic signals (10, 20) of the workpiece are captured by means of a number of sensors (8).

17. The workpiece testing method according to claim 16, characterized in that the sensor (8) is mounted on the workpiece (5) prior to capturing the ultrasonic signals (10, 20) of the workpiece (5).

18. The workpiece testing method according to claim 5, characterized in that during the machining of the workpiece (5), position values corresponding to a momentary machining position (P1, P2) and/or a momentary path (11) between the momentary machining position (P1, P2) and a sensor position, and/or
time values corresponding to a time at which the ultrasonic waves (9, 19) are produced at the associated momentary machining position (P1, P2) are continuously captured, determined, and/or provided, and/or
running time values corresponding to a running time of the ultrasonic waves (9, 19) from the associated momentary machining position (P1, P2) to the sensor position are captured, determined, and/or provided.

19. The workpiece testing method according to claim 6, characterized in that during the machining of the workpiece (5), position values corresponding to a momentary machining position (P1, P2) and/or a momentary path (11) between the momentary machining position (P1, P2) and a sensor position, and/or
time values corresponding to a time at which the ultrasonic waves (9, 19) are produced at the associated momentary machining position (P1, P2) are continuously captured, determined, and/or provided, and/or
running time values corresponding to a running time of the ultrasonic waves (9, 19) from the associated momentary machining position (P1, P2) to the sensor position are captured, determined, and/or provided.

20. The workpiece testing method according to claim 7, characterized in that during the machining of the workpiece (5), position values corresponding to a momentary machining position (P1, P2) and/or a momentary path (11) between the momentary machining position (P1, P2) and a sensor position, and/or
time values corresponding to a time at which the ultrasonic waves (9, 19) are produced at the associated momentary machining position (P1, P2) are continuously captured, determined, and/or provided, and/or
running time values corresponding to a running time of the ultrasonic waves (9, 19) from the associated momentary machining position (P1, P2) to the sensor position are captured, determined, and/or provided.
